(19) United States
(12) Patent Application Publication
(10) Pub. No.: US 2001/0036501 A1
(43) Pub. Date: Nov. 1, 2001

(54) Carotenoid containing product

(75) Inventor: Sheila Ann Wiseman, Vlaardingen (NL)

Correspondence Address: UNILEVER, PATENT DEPARTMENT, 45 RIVER ROAD, EDGEWATER, NJ, 07020, US

(73) Assignee: Lipton, Division of Conopco, Inc.

(21) Appl. No.: 09/842,338

(22) Filed: Apr. 25, 2001

(30) Foreign Application Priority Data
Apr. 27, 2000 (EP) 00201503.0

(51) Int. Cl. A23L 2/00

(52) U.S. Cl. 426/599

(57) ABSTRACT

A tomato juice product of which the lycopene level is 5 to 25 mg per 100 g, and wherein the product is provided in closed containers comprising from 50 to 150 ml of said product.

### FIELD OF THE INVENTION

The present invention relates to products comprising carotenoids. In particular the invention relates to food products comprising lycopene.

### BACKGROUND OF THE INVENTION

Carotenoids form a large group of compounds, which occur in nature. More than 600 carotenoids are known. Examples of Carotenoids are Lutein, β-carotene, Lycopene and Cryptoxanthin.

Carotenoids have been widely applied in food products for example as colourant, provitamin A ingredients, antioxidants etc.

S. K. Clinton in Nutrition Reviews, volume 56 No 2, February 1998: (I)35-51 describes several health benefits of carotenoids, particularly Lycopene.

The incorporation of lycopene into food products sometimes is disadvantageous because the lycopene may negatively affect the color and/or taste and/or stability of the product. It is the aim of the present invention to avoid one or more of these disadvantages. Furthermore the aim of the invention is to provide a food product which can be easily stored over prolonged periods and of which the daily (or twice daily) use of a single dose provides the consumer with the desired amount of lycopene.

It has been found that a particularly advantageous form of lycopene containing product is a tomato juice product of which the lycopene level is 5 to 25 mg per 100 g, and wherein the product is provided in closed containers comprising from 50 to 150 ml.

### DETAILED DESCRIPTION OF THE INVENTION

Stahl, in American Journal of Clinical Nutrition 2000; 71:1-000 describes the administration of a carotenoid mixture as a dietary supplement to protect the skin against solar radiation. The effectiveness of the mixture is ascribed to the presence of β-carotene.

U.S. Pat. No. 5,290,605 provides a nutritional soft-drink for protection against the danger of exposure to UV light the drink comprising a combination of one or more edible carotenoids, water and a specific physiologically acceptable antioxidant or free-radical scavenger. This document suggests that a number of carotenoids including α, β and γ carotenes, zeaxanthin, lycopene, lutien, crocetin, capsanthin, β-zeacarotene, cryptoxanthin, β-apo-8′-carotenal and β-apo-12′carotenal are suitable for this purpose, with a preference for β-carotene provided they are combined with water and either an antioxidant selected from ascorbic acid and salts thereof or to copherols and/or a free radical scavenger selected from reduced glutathione and coenzyme Q10 are present. Furthermore this document indicates that amounts of carotenoids over 10 times the US recommended daily allowance for provitamin A per liter are to be avoided.

S. K. Clinton in Nutrition Reviews, volume 56 No. 2, February 1998: (I)35-51 describes several health benefits of carotenoids, particularly Lycopene. This article indicates that the possibility that diets low in tomato products and lycopene lead to low concentrations of lycopene in the serum or skin and thus place individuals at greater risk of sunlight-induced skin damage remains to be thoroughly investigated.

Lycopene is a carotenoid which is the main carotenoid as found in tomatoes. Generally the carotenoids in tomato are for 60-65% lycopene the other main carotenoid being γ-carotene at 10-12%. Although other fruits like apricot, guave, watermelon, papaya and pink grapefruit also contain lycopene, the main dietary source of lycopene in the western world is tomatoes.

Typical health effects attributed to the use of lycopene are for example reduction of oxidative damage (e.g. UV protection), reduce the risk to get cancer (for example cancer of the cervix, breast cancer, skin cancer, bladder cancer, prostate cancer) and to reduce cardiovascular diseases.

It has been found that for obtaining the desired health effect the amount of lycopene can best be chosen such that from 5 to 40 mg of lycopene is consumed per day.

Tomato juice for use according to the invention can be obtained by conventional routes such as squeezing, crushing, milling or pressing of tomatoes. Normally tomato juice made from conventional tomatoes would contain levels of lycopene of up to 4 mg per 100 g.

Preferably the tomato juice of the invention is made from tomatoes which are selected for their high lycopene level. For example some variants of tomato tend to have higher levels of lycopene e.g. from 4 up to 8 mg per 100 g tomatoes.

Selection, breeding and genetic modification may equally lead to high lycopene levels in fresh tomatoes e.g. from 5 to 50 mg per 100 g.

Fresh tomatoes also tend to have higher amounts of lycopene than processed tomatoes. Therefore preferably the processing to get the tomato juice and storing conditions of the tomato juice are chosen such that the lycopene level is maintained at a high level.

Typical processing condition to obtain lycopene containing tomato juice is to press the tomatoes at ambient or cooled temperatures, optionally adding further ingredients to the tomato juice optionally pasteurising or sterilising the tomato juice, and packing the tomato juice, whereby the handling conditions are chosen such that exposure to air is minimised and the pasteurising or sterilising conditions (if applicable) are chosen such that the heating period is relatively short.

If desired various ingredients may be added to the tomato juice. For example flavouring ingredients, stabilising ingredients, preservatives, vitamins etc may be added.

Preferably these additives constitute from 0 to 10 wt % of the product, more preferred from 0.01 to 5 wt %.

If the lycopene content of the tomato juice is relatively low, then advantageously further lycopene may be added to the juice to get the desired lycopene level in the product.

In a preferred embodiment of the invention lycopene is supplemented by incorporating into the tomato juice a lycopene concentrate e.g. a lycopene solution or lycopene powder advantageously a natural lycopene. Typical forms of addition are natural tomato extracts as may be obtained from LycoRed.

Preferably the amount of lycopene in the final product is 5 to 40 mg per serving, more preferred 6 to 30 mg, most preferred 7 to 25 mg per serving of tomato juice. These levels ensure that a single serving of the product of the invention provides the desired daily intake of lycopene.

In another preferred embodiment of the invention the level of lycopene in the tomato juice is preferably from 5 to 40 mg lycopene per 100 g product, more preferred 6 to 35 mg/100 g, most preferred 8 to 15 mg per 100 tomato juice.

The serving size of the product of the invention is from 50 to 150 ml, more preferred from 60 to 140 ml, most preferred from 75 to 125 ml.

Particularly preferred is the storage of the tomato juice product in accordance to the invention in closed containers. For example the containers may be sealed or closed with a cap. Especially preferred is the air tight closure, most preferred aseptic packaging.

A particularly preferred embodiment of the inventions involves the use of small bottles as the container for holding the tomato juice. These bottles can be made of any suitable packaging material for example glass, polystyrene, polypropylene or other plastics, lined paper etc. The closure may for example be a conventional cap or alternatively a sealing foil.

Especially advantageous is the packaging of the tomato juice product of the invention is so-called multi-packs, each multi-pack comprising from 2 to 25, more preferred 3 to 10, most preferred 4 to 8 containers according to the invention.

The invention will be illustrated by the following example.

### EXAMPLE I

A tomato juice was obtained by pressing fresh tomatoes and enriching the obtained tomato juice with a 6% lycopene concentrate (ex Lycomat) such that the level of lycopene in the product was 10 mg per 100 g tomato juice.

The tomato juice was flavoured with 0.5 wt % of Worcester sauce. 100 ml portions of the fresh product are packed in plastic bottles having a maximum filling capacity of 110 ml. The bottles are sealed with a foil closure. 6 bottles are paked in a multi-pack, the multipack is stored at refrigeration temperature until consumption.

### EXAMPLE II

The procedure of example I is repeated, however between flavouring and filling into bottles, the product is pasteurised by quickly heating to 112 degrees C. for a period of 10 seconds.

### EXAMPLE III

The procedure of examples I and II was repeated, however the container used was a glass bottle closed by means of a aluminium cap.

1. A tomato juice product of which the lycopene level is 5 to 25 mg per 100 g, and wherein the product is provided in closed containers comprising from 50 to 150 ml of said product.

2. A product according to claim 1, wherein the lycopene level is 6 to 35 mg per 100 g tomato juice, more preferred 8 to 15 mg per 100 g tomato juice.

3. A product according to claim 1, wherein the container comprises from 75 to 125 ml of tomato juice.

4. A product according to claim 1, wherein the tomato juice comprises a lycopene concentrate in an amount such that the total level of lycopene is from 5 to 25 mg per 100 g, more preferred 6 to 35 mg per 100 g.

5. A product according to claim 1 comprising from 5 to 40 mg lycopene per container, more preferred 6 to 30 mg, most preferred 7 to 25 mg per container of tomato juice.

6. A product according to claim 1, wherein the container is a bottle, especially a plastic or glass bottle.

7. A product according to claim 1, wherein the product is pasteurised or sterilised.

8. A multi-pack product comprising from 2 to 25 containers according to one or more of the preceding claims.
